(19) United States
(12) Patent Application Publication
(10) Pub. No.: US 2024/0376413 A1
(43) Pub. Date: Nov. 14, 2024

(54) Alcoholic Beverages with Reduced Bitterness Using Salt Rich in Minerals and Preparation Method Thereof

(71) Applicant: BO HAE BREWERY CO., LTD., Mokpo-si (KR)

(72) Inventors: Jaewoong LIM, Suwon-si (KR); Jihwan IM, Gwangju (KR); Sua SHIM, Gwangju (KR); Seong Wan PARK, Gwangju (KR); Jihoon NA, Gwangju (KR); Ji Yun KIM, Gwangju (KR)

(21) Appl. No.: 18/029,473

(22) PCT Filed: Jul. 20, 2022
(86) PCT No.: PCT/KR2022/010601

§ 371 Date: Mar. 30, 2023

(30) Foreign Application Priority Data
Dec. 31, 2021 (KR) 10-2021-0194211

(51) Int. Cl. C12G 3/04; A23L 27/00

(52) U.S. Cl. CPC C12G 3/04; A23L 27/84; A23L 27/86

(57) ABSTRACT

The present invention provides alcoholic beverages comprising salt and a preparation method thereof, and specifically, provides an effect of shielding bitterness as salt is comprised.

### TECHNICAL FIELD

The present description provides alcoholic beverages comprising salt and a preparation method thereof, and specifically, provides alcoholic beverages with reduced bitterness as salt is comprised and a preparation method thereof.

### BACKGROUND ART

Recently, as consumers' desires for alcoholic beverages are diversified and the tendency to seek high-quality alcoholic beverages is strengthened, the need for development of alcoholic beverages with excellent flavor continues to increase. The most important factor that determines the quality of alcoholic beverages is fragrance, and many components are involved in the flavor of alcoholic beverages, and components found to directly affect this include acetaldehyde, ethyl acetate, ethyl caproate, isoamylacetate, isoamylalcohol, phenylethanol, phenylethyl acetate, and the like. When the combination and content of fragrance components involved in the fragrance of alcoholic beverages are adjusted, alcoholic beverages with excellent fragrance can be obtained, but in order to obtain alcoholic beverages in which the fragrance, alcohol odor, bitterness, preference and the like of alcoholic beverages are complexly improved, additional research is needed.

Ethanol comprised in alcoholic beverages has negative flavor such as unique alcohol flavor and characteristic bitterness and the like, and the higher the alcohol concentration, the greater this negative flavor appears. In particular, sales growth of alcoholic beverages including high concentration alcohol such as Soju, whiskey, liqueur or rum is slowing due to such negative flavor.

Conventionally, in order to soften the taste of alcoholic beverages and to mask bitterness and tangy taste, large amounts of saccharides such as sugar or high fructose corn syrup or the like have been added to alcoholic beverages, and in the media, it has been raised as an issue because the amount of sugar contained in alcoholic beverages is excessive and calories are high. As a result, negative perception of alcoholic beverages by consumers is increasing. Accordingly, there is an increasing need for a method for reducing characteristic bitterness of alcoholic beverages without using saccharides such as sugar and the like.

### DISCLOSURE

### Technical Problem

One embodiment of the present description provides an alcoholic beverage, comprising at least one salt selected from the group consisting of lake salt, rock salt and solar salt and ethanol.

Another embodiment provides a preparation method of an alcoholic beverage and/or a method of shielding bitterness of an alcoholic beverage, comprising adding at least one salt selected from the group consisting of lake salt, rock salt and solar salt to ethanol; and
stirring the salt-added ethanol.

Other embodiment provides an alcoholic beverage, prepared by the preparation method of an alcoholic beverage.

Other embodiment provides a use for shielding bitterness of an alcoholic beverage of at least one salt selected from the group consisting of lake salt, rock salt and solar salt.

Other embodiment provides a composition for shielding bitterness of an alcoholic beverage comprising at least one salt selected from the group consisting of lake salt, rock salt and solar salt.

### Technical Solution

As a result of research efforts to reduce odor and bitterness of alcoholic beverages, the present inventors have confirmed that the bitterness can be effectively reduced when salt is added, and furthermore, have confirmed that alcoholic beverages with enhanced preference as the bitterness is reduced by adjusting the optimum content, preparation conditions and the like of salt, thereby completing the present invention. The alcoholic beverages provided in the present description have reduced bitterness characteristic of alcohol by adding salt, not saccharides, and the alcoholic beverages provided in the present description have a characteristic of reduced bitterness than other types of alcoholic beverages, and specifically, they have a characteristic of reduced bitterness compared to alcoholic beverages that do not comprise at least one salt selected from the group consisting of lake salt, rock salt and solar salt, but not limited thereto.

One embodiment of the present description provides an alcoholic beverage, comprising salt and ethanol.

Another embodiment provides an alcoholic beverage comprising at least one salt selected from the group consisting of lake salt, rock salt and solar salt and ethanol.

Other embodiment provides a preparation method of alcoholic beverages and/or a method for reducing bitterness of alcoholic beverages, comprising adding at least one salt selected from the group consisting of lake salt, rock salt and solar salt to ethanol; and
stirring the salt-added ethanol.

Other embodiment further comprises diluting alcohol (for example, spirit and/or ethanol) before the adding salt (primary diluting step) and/or diluting the salt-added ethanol before the stirring (secondary diluting step), in the preparation method of alcoholic beverages and/or method for reducing bitterness of alcoholic beverages, but not limited thereto.

The alcohol diluted in the primary diluting step may be used as ethanol in the adding salt, and the ethanol diluted in the secondary diluting step may be used as ethanol in the stirring, but not limited thereto.

Other embedment of the present description provides alcoholic beverages, prepared by the preparation method of alcoholic beverages.

Hereinafter, the present invention will be described in more detail.

In the present description, “alcoholic beverages” may be refined rice wine, Takju, Soju, and the like, and specifically, may be diluted or distilled Soju, but not limited thereto.

The “diluted Soju” may mean Soju produced by adding water to reduce the alcohol content, a sweetener to give sweetness, and an acidulent to sourness and the like to spirit.

The “distilled Soju” may mean an alcoholic beverage produced by distilling crude liquor made of grains.

The ethanol may be provided as spirit or distilled Soju crude solution or a combination thereof. Specifically, the spirit may be provided as fermented spirit, deodorized spirit and/or distilled Soju crude solution, and the fermented spirit may be prepared by fermenting with starch or sugar-containing materials and the like and purifying to an alcohol content of 95 degrees or higher, and according to Korean Liquor Tax Act, spirit refers to that starch-containing materials or sugar-containing materials are fermented and distilled to an alcohol content of 85 degrees or higher. In addition, it may be prepared by a continuous distillation method after being fermented by adding glycosylase to starch such as grains, tapioca, sweet potatoes, and the like or sugar (candy) raw materials, but not limited thereto.

In the present description, “lake salt” means salt produced in a lake with higher salinity than general lakes, and for example, it may be produced as the moisture is evaporated after land that was originally sea turned into a lake due to tectonic fluctuation and the like. A representative example of the lake salt includes Andes lake salt, and the like. The “Andes lake salt” means natural pure salt produced by nature as the clean and clear first grade water from the Andean glacier is melted and flows, and performs purifying and washing actions and repeats them for tens of thousands of years, and passes through an evaporation process of clear wind and sun, thereby removing impurities.

In the present description, “rock salt (halite)” may mean that seawater evaporates and salt remains as a mineral. As a representative example of the rock salt includes Himalaya pink salt and the like. The “Himalaya pink salt” is rock salt produced in Pakistan mountains, particularly, Khewra mine, and the like, and is rich in minerals and has a pink color.

In the present description, “solar salt” means salt produced by evaporating seawater in a salt pond, and is distinguished from salt extracted from lakes and sedimentary mines. In one embodiment, the solar salt may be gray salt which is salt produced on the tidal flat soil bottom after compacting and flattening it when salt is produced in a salt pond. In addition, the solar salt may be white salt produced by laying a vinyl sheet, tile, glass and the like on a salt pond to facilitate evaporation, but not limited thereto.

The total content of the salt in the alcoholic beverages provided herein may be comprised in 0.00001 to 0.01% (w/v), 0.00001 to 0.005% (w/v), 0.00001 to 0.001% (w/v), 0.00001 to 0.0008% (w/v), 0.00001 to 0.0006% (w/v), 0.00005 to 0.01% (w/v), 0.00005 to 0.005% (w/v), 0.00005 to 0.001% (w/v), 0.00005 to 0.0008% (w/v), 0.00005 to 0.0006% (w/v), 0.0001 to 0.01% (w/v), 0.0001 to 0.005% (w/v), 0.0001 to 0.001% (w/v), 0.0001 to 0.0008% (w/v), 0.0001 to 0.0006% (w/v), 0.0002 to 0.01% (w/v), 0.0002 to 0.005% (w/v), 0.0002 to 0.001% (w/v), 0.0002 to 0.0008% (w/v), 0.0002 to 0.0006% (w/v), 0.0004 to 0.01% (w/v), 0.0004 to 0.005% (w/v), 0.0004 to 0.001% (w/v), 0.0004 to 0.0008% (w/v), or 0.0004 to 0.0006% (w/v), and for example, may be 0.0005% (w/v), but not limited thereto.

In the alcoholic beverages, preparation method of alcoholic beverages, use for shielding bitterness of alcoholic beverages, composition for shielding bitterness of alcoholic beverages and/or method for shielding bitterness of alcoholic beverages, the salt comprises lake salt, rock salt and solar salt, and the ratio between them may be 6 to 8 parts by weight, 6 to 7.5 parts by weight, 6.5 to 8 parts by weight or 6.5 to 7.5 parts by weight of lake salt, and 1 to 3 parts by weight, 1 to 2.5 parts by weight, 1.5 to 3 parts by weight, or 1.5 to 2.5 parts by weight of rock salt, based on 1 part by weight of solar salt.

More specifically, the salt may comprise lake salt, rock salt and solar salt at a weight ratio of 6:3:1 to 8:1:1, 6:3:1 to 7.5:1.5:1, 6.5:2.5:1 to 8:1:1, or 6:3:1 to 7.5:1.5:1 (lake salt:rock salt:solar salt), respectively, and for example, may comprise them at a weight ratio of 6:3:1, 7:2:1, or 8:1:1, but not limited thereto.

The alcoholic beverages may comprise ethanol at a concentration of 5 to 30% (v/v), 5 to 25% (v/v), 5 to 20% (v/v), 5 to 17% (v/v), 10 to 30% (v/v), 10 to 25% (v/v), 10 to 20% (v/v), 10 to 17% (v/v), 13 to 30% (v/v), 13 to 25% (v/v), 13 to 20% (v/v), 13 to 17% (v/v), 16 to 30% (v/v), 16 to 25% (v/v), 16 to 20% (v/v), or 16 to 17% (v/v) based on 100% of the alcoholic beverage volume, and for example, may comprise it at a concentration of 16.8% (v/v), but not limited thereto.

The concentration of the ethanol used in the preparation method of alcoholic beverages and/or method for shielding bitterness of alcoholic beverages may be 10 to 50% (v/v), 10 to 45% (v/v), 10 to 40% (v/v), 10 to 38% (v/v), 10 to 35% (v/v), 10 to 30% (v/v), 10 to 25% (v/v), 10 to 20% (v/v), 15 to 50% (v/v), 15 to 45% (v/v), 15 to 40% (v/v), 15 to 38% (v/v), 15 to 35% (v/v), 15 to 30% (v/v), 15 to 25% (v/v), 15 to 20% (v/v), 20 to 50% (v/v), 20 to 45% (v/v), 20 to 40% (v/v), 20 to 38% (v/v), 20 to 35% (v/v), 20 to 30% (v/v), 20 to 25% (v/v), 25 to 50% (v/v), 25 to 45% (v/v), 25 to 40% (v/v), 25 to 38% (v/v), 25 to 35% (v/v), 25 to 30% (v/v), 30 to 50% (v/v), 30 to 45% (v/v), 30 to 40% (v/v), 30 to 38% (v/v), 30 to 35% (v/v), 35 to 50% (v/v), 35 to 45% (v/v), 35 to 40% (v/v), or 35 to 38% (v/v), and for example, it may 20% (v/v), 25% (v/v), 30% (v/v), or 38% (v/v), but not limited thereto.

In the present description, “alcohol proof” means a ratio expressed as a percentage (percent) of the volume concentration of ethanol based on an alcoholic beverage. In the alcoholic beverage, at 15° C., the alcohol proof may be 5.0 to 30.0 proof, 5.0 to 25.0 proof, 5.0 to 20.0 proof, 5.0 to 17.0 proof, 10.0 to 30.0 proof, 10.0 to 25.0 proof, 10.0 to 20.0 proof, 10.0 to 17.0 proof, 13.0 to 30.0 proof, 13.0 to 25.0 proof, 13.0 to 20.0 proof, 13.0 to 17.0 proof, 16.0 to 30.0 proof, 16.0 to 25.0 proof, 16.0 to 20.0 proof, or, 16.0 to 17.0 proof, and for example, it may be 16.8 proof, but not limited thereto.

In the preparation method of alcoholic beverages and/or method for shielding bitterness of alcoholic beverages, in the diluting alcohol, the alcohol (for example, ethanol) may be provided as spirit or distilled Soju crude solution or a combination thereof, and specifically, the spirit may be fermented spirit, deodorized spirit and/or distilled Soju crude solution, and the fermented spirit may be prepared by a continuous distillation method after being fermented by adding glycosylase to starch such as grains, tapioca, sweet potatoes, and the like or sugar (candy) raw materials, but not limited thereto.

In the preparation method of alcoholic beverages and/or method for shielding bitterness of alcoholic beverages, the primary diluting step may dilute alcohol (for example, spirit and/or ethanol) to a concentration of 10 to 50% (v/v), 10 to 45% (v/v), 10 to 40% (v/v), 10 to 38% (v/v), 10 to 35% (v/v), 10 to 30% (v/v), 10 to 25% (v/v), 10 to 20% (v/v), 15 to 50% (v/v), 15 to 45% (v/v), 15 to 40% (v/v), 15 to 38% (v/v), 15 to 35% (v/v), 15 to 30% (v/v), 15 to 25% (v/v), 15 to 20% (v/v), 20 to 50% (v/v), 20 to 45% (v/v), 20 to 40% (v/v), 20 to 38% (v/v), 20 to 35% (v/v), 20 to 30% (v/v), 20 to 25% (v/v), 25 to 50% (v/v), 25 to 45% (v/v), 25 to 40% (v/v), 25 to 38% (v/v), 25 to 35% (v/v), 25 to 30% (v/v), 30 to 50% (v/v), 30 to 45% (v/v), 30 to 40% (v/v), 30 to 38% (v/v), 30 to 35% (v/v), 35 to 50% (v/v), 35 to 45% (v/v), 35 to 40% (v/v), or 35 to 38% (v/v), and for example, it may dilute it to a concentration of 20% (v/v), 25% (v/v), 30% (v/v), or 38% (v/v), but not limited thereto.

In the preparation method of alcoholic beverages and/or method for shielding bitterness of alcoholic beverages, the secondary diluting step may dilute alcohol (for example, spirit and/or ethanol) to a concentration of 5 to 30% (v/v), 5 to 25% (v/v), 5 to 20% (v/v), 5 to 17% (v/v), 10 to 30% (v/v), 10 to 25% (v/v), 10 to 20% (v/v), 10 to 17% (v/v), 13 to 30% (v/v), 13 to 25% (v/v), 13 to 20% (v/v), 13 to 17% (v/v), 16 to 30% (v/v), 16 to 25% (v/v), 16 to 20% (v/v), or 16 to 17% (v/v), and for example, it may dilute it to a concentration of 16.8% (v/v), but not limited thereto.

In the preparation method of alcoholic beverages and/or method for shielding bitterness of alcoholic beverages, the salt may be added so that the total content in the alcoholic beverage is 0.00001 to 0.01% (w/v), 0.00001 to 0.005% (w/v), 0.00001 to 0.001% (w/v), 0.00001 to 0.0008% (w/v), 0.00001 to 0.0006% (w/v), 0.00005 to 0.01% (w/v), 0.00005 to 0.005% (w/v), 0.00005 to 0.001% (w/v), 0.00005 to 0.0008% (w/v), 0.00005 to 0.0006% (w/v), 0.0001 to 0.01% (w/v), 0.0001 to 0.005% (w/v), 0.0001 to 0.001% (w/v), 0.0001 to 0.0008% (w/v), 0.0001 to 0.0006% (w/v), 0.0002 to 0.01% (w/v), 0.0002 to 0.005% (w/v), 0.0002 to 0.001% (w/v), 0.0002 to 0.0008% (w/v), 0.0002 to 0.0006% (w/v), 0.0004 to 0.01% (w/v), 0.0004 to 0.005% (w/v), 0.0004 to 0.001% (w/v), 0.0004 to 0.0008% (w/v), or 0.0004 to 0.0006% (w/v), and for example, it may be added so as to be 0.0005% (w/v), but not limited thereto.

In the preparation method of alcoholic beverages and/or method for shielding bitterness of alcoholic beverages, the stirring may be performed at 1 to 30° C., 1 to 25° C., 1 to 20° C., 1 to 17° C., 5 to 30° C., 5 to 25° C., 5 to 20° C., 5 to 17° C., 10 to 30° C., 10 to 25° C., 10 to 20° C., 10 to 17° C., 13 to 30° C., 13 to 25° C., 13 to 20° C., or 13 to 17° C., and for example, it may be performed at 15° C., but not limited thereto.

In the preparation method of alcoholic beverages and/or method for shielding bitterness of alcoholic beverages, the stirring may be performed under a condition in that the pH of the alcohol is 5 to 7, but not limited thereto.

In the preparation method of alcoholic beverages and/or method for shielding bitterness of alcoholic beverages, the stirring may be performed by aeration, ultrasonication and/or hot water treatment, but not limited thereto.

The aeration may be performed for 1 minute to 5 minutes, 1 minute to 4 minutes, 1 minute to 3 minutes, 1 minute to 2 minutes and 40 [symbol] , 2 minutes to 5 minutes, 2 minutes to 4 minutes, 2 minutes to 3 minutes, 2 minutes to 2 minutes and 40 seconds, 2 minutes and 10 seconds to 5 minutes, 2 minutes and 10 seconds to 4 minutes, 2 minutes and 10 seconds to 3 minutes, 2 minutes and 10 seconds to 2 minutes and 40 seconds, 2 minutes and 20 seconds to 5 minutes, 2 minutes and 20 seconds to 4 minutes, 2 minutes and 20 seconds to 3 minutes, or 2 minutes and 20 seconds to 2 minutes and 40 seconds, and for example, it may be performed for 2 minutes and 30 seconds, but not limited thereto.

In the preparation method of alcoholic beverages and/or method for shielding bitterness of alcoholic beverages,
standing the stirred ethanol; and
filtering the stood ethanol may be further comprised, but not limited thereto.

The standing may be performed at 1 to 30° C., 1 to 25° C., 1 to 20° C., 1 to 17° C., 5 to 30° C., 5 to 25° C., 5 to 20° C., 5 to 17° C., 10 to 30° C., 10 to 25° C., 10 to 20° C., 10 to 17° C., 13 to 30° C., 13 to 25° C., 13 to 20° C., or 13 to 17° C., and for example, it may be performed at 15° C., but not limited thereto.

The alcoholic beverages prepared by the preparation method of alcoholic beverages may have a characteristic of shielding bitterness compared to alcoholic beverages not comprising at least one salt selected from the group consisting of lake salt, rock salt and solar salt, but not limited thereto.

For the alcoholic beverages provided in the present description, the degree of bitterness may be confirmed by sensory evaluation, and the sensory evaluation may be tested with 5 points as the highest point, and the test may be conducted on the basis of that the closer to 5 points, the weaker the bitterness. The bitterness score of the alcoholic beverages measured through the corresponding sensory evaluation may increase to 10% or more, 15% or more, 20% or more, 25% or more, 30% or more, 33% or more, or 34% or more, compared to alcoholic beverages not comprising at least one salt selected from the group consisting of lake salt, rock salt and solar salt, and the increase in the score may mean that the bitterness is shown as relatively weak, but not limited thereto.

In the preparation method of alcoholic beverages and/or method for shielding bitterness of alcoholic beverages, the alcoholic beverages may comprise ethanol at a concentration of 5 to 30% (v/v), 5 to 25% (v/v), 5 to 20% (v/v), 5 to 17% (v/v), 10 to 30% (v/v), 10 to 25% (v/v), 10 to 20% (v/v), 10 to 17% (v/v), 13 to 30% (v/v), 13 to 25% (v/v), 13 to 20% (v/v), 13 to 17% (v/v), 16 to 30% (v/v), 16 to 25% (v/v), 16 to 20% (v/v), or 16 to 17% (v/v), based on 100% of the alcoholic beverage volume, and for example, it may comprise it at a concentration of 16.8% (v/v), but not limited thereto.

### Advantageous Effects

The alcoholic beverages provided in the present description has a characteristic in which bitterness is shielded by adding salt to remove characteristic bitterness of alcoholic beverages.

### BRIEF DESCRIPTION OF THE DRAWINGS

FIGS. 1 to 3 are schematic diagrams showing the preparation steps according to various preparation methods which prepare Soju.

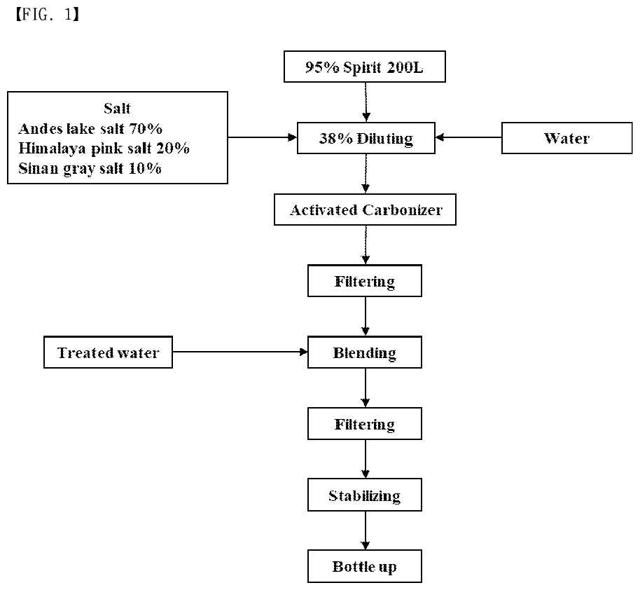

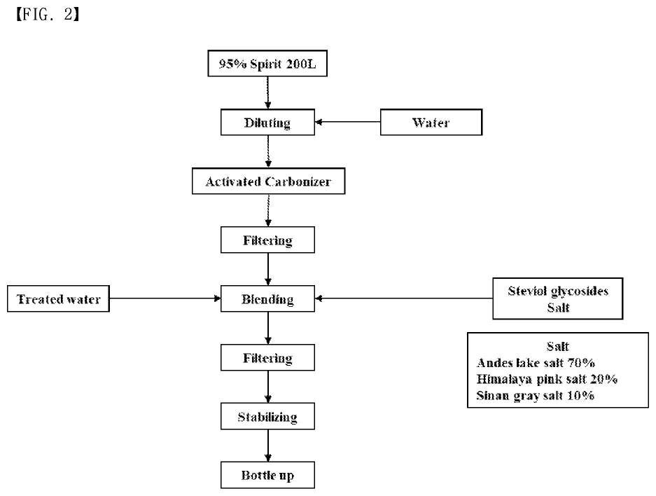

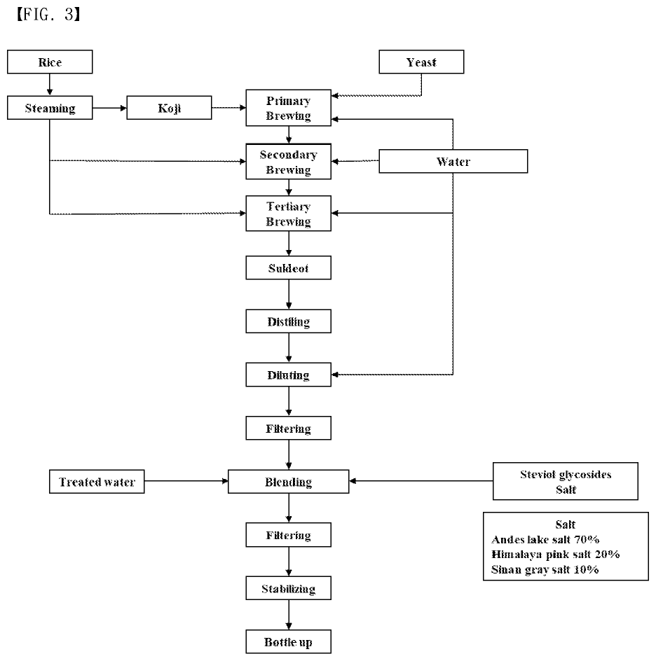

### MODE FOR INVENTION

Hereinafter, the present invention will be described in more detail by examples. However, the following examples are intended to illustrate the present invention, but do not limit the scope of the present invention.

### Example 1. Preparation of Soju Comprising Andes Lake Salt, Himalaya Pink Salt and Gray Salt

### Example 1-1. Preparation of Soju Comprising Salt

Deionized water was added to 95% (v/v) spirit so that the alcohol (ethanol) concentration was to be 38% (v/v). 0.088% (w/v) of activated carbon was added to the diluted spirit, stirred for 8 hours and passed through diatomaceous earth, followed by deodorization and filtration. Deionized water and stevioside 0.003% (w/v), and table salt 0.0005% (w/v) were added to the deodorized and filtered spirit so that the alcohol content became 16.8% (v/v), and it was stirred under the condition of 15° C., aeration for 2 minutes and 30 seconds and the pH of the spirit of 5.5˜6.5.

### Example 1-2. Mineral Content Analysis Depending on Salt Type and Soju Preparation According Thereto

In order to prepare Soju having the best mineral content, at first, the mineral content comprised in various types of salt was analyzed.

Specifically, in the preparation method of Example 1-1, by adding Andes lake salt (Argentina), Himalaya pink salt (Pakistan), Sinan gray salt (Jeollanam, Sinan-gun) and solar salt (white salt) and purified salt commercially purchased of 0.0005% (w/v), respectively, Soju was prepared by the substantially same method, and the mineral content was measured by ion chromatography under cation and anion conditions of Table 1 below, and the result was shown in Table 2 below.

TABLE 1

| Condition | Cation | Anion |
|---|---|---|
| System | Metrohm professional ion | Metrohm professional ion |
| | chromatography 940 Vario | chromatography 940 Vario |
| Column | Metrosep C 4 (150*4 mm) | Metrosep A Supp 5 (250*4.6 |
| | | mm) |
| Eluent | Mpak C4 Eluent | Mpak A Supp 5 Eluent |
| Flow rate | 0.5 ml/min | 0.7 ml/min |
| Injection | 10 ul | 10 ul |
| Volume | | |
| Detector | Metrohm Professional | Metrohm Professional |
| | Detector 945 Vario | Detector 945 Vario |
| Supressor | — | 100 mM H₂SO₄ |

TABLE 2

| Classification | Na | Mg | Ca | Cl |
|---|---|---|---|---|
| Himalaya pink salt | 4348.451 | 10.117 | 14.383 | 6231.801 |
| Andes lake salt | 4042.007 | — | 11.548 | 6443.801 |
| Sinan gray salt | 4115.762 | — | 37.976 | 5978.09 |
| Solar salt | 4259.497 | 87.693 | 13.256 | 5615.446 |
| Purified salt | 4279.648 | — | — | 6226.956 |

(The unit of Table 2 above is ppm)

As a result, in consideration of Mg, Ca, Cl contents in minerals causing bitterness, the ratio of Andes lake salt among natural salt with a small content of Mg and Ca was set high, and then, considering a sensory aspect, the ratio was set in order of Himalaya pink salt and gray salt. In consideration of this result, table salt having specific constituent contents of Table 3 below was prepared.

TABLE 3

| Classification | Andes lake salt | Himalaya pink salt | Gray salt |
|---|---|---|---|
| Salt 1 | 5 | 5 | 0 |
| Salt 2 | 5 | 0 | 5 |
| Salt 3 | 0 | 5 | 5 |
| Salt 4 | 5 | 3 | 2 |
| Salt 5 | 6 | 3 | 1 |
| Salt 6 | 7 | 2 | 1 |
| Salt 7 | 8 | 1 | 1 |

(In Table 3 above, the salt content in the table salt means a weight ratio in the total table salt (e.g.: Salt 1 means comprising Andes lake salt and Himalaya pink salt at a weight ratio of 5:5))

Using salts 1 to 7 having the constituent contents of Table 3 above as table salt, Soju of Samples 1 to 7 was prepared by the substantially same method as Example 1-1 above, respectively. The mineral content in the Soju was measured by the substantially same method as the mineral measurement method, and the result was shown in Table 4 below.

TABLE 4

| Classification | Na | Mg | Ca | Cl |
|---|---|---|---|---|
| Sample 1 (comprising Salt 1) | 4465 | 32 | 44 | 6778 |
| Sample 2 (comprising Salt 2) | 4336 | 43 | — | 6944 |
| Sample 3 (comprising Salt 3) | 4927 | 44 | — | 6707 |
| Sample 4 (comprising Salt 4) | 4017 | 37 | — | 6093 |
| Sample 5 (comprising Salt 5) | 4824 | 32 | — | 6241 |
| Sample 6 (comprising Salt 6) | 4093 | 32 | — | 6686 |
| Sample 7 (comprising Salt 7) | 3965 | 31 | — | 6707 |

(The unit of Table 4 above is ppm)

### Example 2. Sensory Evaluation Depending on Salt Type and Salt Content Comprised in Soju

### Example 2-1. Sensory Test Depending on Salt Type

For Soju comprising Andes lake salt, Himalaya pink salt, Sinan gray salt and solar salt at 0.0005% (w/v) of the total Soju content, respectively, prepared in Example 1-2 above, a sensory test related to bitterness depending on the salt type comprised in Soju was conducted.

Specifically, the sensory test was performed as a blind test that did not provide any information by selecting 10 professionally trained sensory inspectors in their 20s and 50s at a ratio of 1:1 between male and female, and the condition of samples was carried out with two samples in a room temperature state and a refrigerated state. As for the score, the test was conducted by establishing a standard as 5 points was the highest point, and the closer to 5 points, the weaker the bitterness, and the result was shown in Table 5 below.

TABLE 5

| | Himalaya pink | Andes lake | Sinan gray | Solar |
|---|---|---|---|---|
| Classification | salt | salt | salt | salt |
| Sensory | 4.5 | 4.7 | 3.9 | 3.4 |
| inspector 1 | | | | |
| Sensory | 4.2 | 4.8 | 3.9 | 3.5 |
| inspector 2 | | | | |
| Sensory | 4.4 | 4.7 | 4.1 | 3.7 |
| inspector 3 | | | | |
| Sensory | 4.3 | 4.7 | 3.8 | 3.5 |
| inspector 4 | | | | |
| Sensory | 4.3 | 4.6 | 4.4 | 3.8 |
| inspector 5 | | | | |
| Sensory | 4.5 | 4.8 | 3.9 | 3.7 |
| inspector 6 | | | | |
| Sensory | 4.3 | 4.7 | 3.8 | 3.5 |
| inspector 7 | | | | |
| Sensory | 4.4 | 4.8 | 4.1 | 3.8 |
| inspector 8 | | | | |
| Sensory | 4.7 | 4.9 | 4.1 | 3.6 |
| inspector 9 | | | | |
| Sensory | 4.6 | 4.8 | 4.4 | 3.8 |
| inspector 10 | | | | |
| Average | 4.42 | 4.75 | 4.04 | 3.63 |

(In Table 5 above, the higher the score is (the closer to 5 points), it means that the less the bitterness)

As a result, it was confirmed that the bitterness of Soju was reduced when three kinds of the salts were added to Soju, as the average score of the sensory test for Andes lake salt, Himalaya pink salt and Sinan gray salt exceeded 4 points, and the solar salt didn't exceed 4 points, and in particular, it was confirmed that the score of Soju comprising Andes lake salt was high.

### Example 2-2. Sensory Test Depending on Salt Content

For Samples 1 to 7 comprising Andes lake salt, Himalaya pink salt and Sinan gray salt in an amount of 0.0005% (w/v) of the total Soju content in total at various ratios prepared in Example 1-2 above, a sensory test related to bitterness depending on the salt content comprised in the Soju was conducted by the substantially same method as Example 2-1 above, and the result was shown in Table 6 below.

TABLE 6

| Classification | Sample 1 | Sample 2 | Sample 3 | Sample 4 | Sample 5 | Sample 6 | Sample 7 |
|---|---|---|---|---|---|---|---|
| Sensory | 3.9 | 3.5 | 3.2 | 4.2 | 4.5 | 4.8 | 4.7 |
| inspector 1 | | | | | | | |
| Sensory | 3.9 | 3.5 | 3.5 | 4.1 | 4.2 | 4.9 | 4.5 |
| inspector 2 | | | | | | | |
| Sensory | 3.7 | 3.2 | 3.5 | 4.2 | 4.5 | 4.8 | 4.6 |
| inspector 3 | | | | | | | |
| Sensory | 3.8 | 3.5 | 3.2 | 4.5 | 4.4 | 4.8 | 4.5 |
| inspector 4 | | | | | | | |
| Sensory | 4.1 | 3.4 | 3.6 | 4.3 | 4.3 | 4.7 | 4.5 |
| inspector 5 | | | | | | | |
| Sensory | 3.7 | 3.5 | 3.5 | 4.2 | 4.2 | 4.9 | 4.6 |
| inspector 6 | | | | | | | |
| Sensory | 3.5 | 3.5 | 3.8 | 4.1 | 4.3 | 4.8 | 4.6 |
| inspector 7 | | | | | | | |
| Sensory | 3.8 | 3.5 | 3.4 | 4.2 | 4.5 | 4.9 | 4.4 |
| inspector 8 | | | | | | | |
| Sensory | 3.9 | 3.2 | 3.5 | 4.3 | 4.5 | 4.9 | 4.5 |
| inspector 9 | | | | | | | |
| Sensory | 4.1 | 3.4 | 3.5 | 4.3 | 4.3 | 4.8 | 4.5 |
| inspector 10 | | | | | | | |
| Average | 3.84 | 3.47 | 3.47 | 4.26 | 4.37 | 4.83 | 4.54 |

(In Table 6 above, the higher the score is (the closer to 5 points), it means that the less the bitterness)

As a result, as the sensory test score of Sample 6 was relatively high, when salt at a weight ratio of 7:2:1 (Andes lake salt:Himalaya pink salt gray salt) was comprised, it was confirmed that the bitterness was reduced the most, and it was confirmed that Soju comprising salt at a weight ratio of 8:1:1 and 6:3:1 (Andes lake salt:Himalaya pink salt:gray salt) (Sample 7 and Sample 5) also had a high bitterness reducing score.

### Example 2-3. Sensory Test of Bitterness Shielded Soju

A sensory test for the overall taste other than bitterness of Sample 6 Soju determined as the bitterness was reduced the most as the result of the sensory test of Example 2-2 above was performed.

Specifically, the test was performed for the sensory inspectors of Example 2-1 above, and a sensory test for the overall taste for sweetness and bitterness and the like was performed, and the test was performed under the condition of the samples in a room temperature state commonly exposed and a refrigerated state commonly storing Soju. As for the score, the evaluation was conducted for the overall taste of sweetness and bitterness by setting 5 points to the highest point, and the closer to 5 points, it means the overall taste was excellent, and the result was shown in Table 7 below.

TABLE 7

| Classification | Sample 6 |
|---|---|
| Sensory inspector 1 | 4.8 |
| Sensory inspector 2 | 4.9 |
| Sensory inspector 3 | 4.9 |
| Sensory inspector 4 | 5 |
| Sensory inspector 5 | 4.9 |
| Sensory inspector 6 | 4.9 |
| Sensory inspector 7 | 4.8 |
| Sensory inspector 8 | 5 |
| Sensory inspector 9 | 5 |
| Sensory inspector 10 | 4.9 |
| Average | 4.91 |

(In Table 7 above, the higher the score is (the closer to 5 points), it means that the overall taste is good) As a result, all the sensory inspectors for the corresponding Soju of Sample 6 gave a high score, and it had high scores of 4.91 on average, and therefore, it was confirmed that the bitterness was reduced and the overall taste was good.

### Example 2-4. Comparison to Case of Adding Sugar Instead of Salt

For comparison of the bitterness of Soju of Sample 6, which was highly evaluated in Example 2-2 above, to other products in which sugar was added instead of salt, a sensory test was conducted.

Specifically, by the substantially same method as the method of Example 2-2, by comparing Soju of Comparison A to Comparison E, the sensory test was performed, and the composition of Soju of Comparison A to Comparison E was shown in Table 8 below, and the sensory test result was shown in Table 9 below.

TABLE 8

| Classification | Comparison A | Comparison B | Comparison C | Comparison D | Comparison E |
|---|---|---|---|---|---|
| Composition | Purified water, | Purified water, | Purified water, | Purified water, | Purified water, |
| | spirit, | spirit, | spirit, | spirit, xylitol, | spirit, |
| | fructose, | fructose, rice | distilled Soju | enzyme-treated | fructose, |
| | enzyme-treated | distilled Soju | (Barley), other | stevia, steviol | enzyme-treated |
| | stevia, | crude solution, | fructose, | glycoside, | stevia, xylitol, |
| | erythritol, | enzyme-treated | enzyme-treated | glycine, | erythritol, L- |
| | tomatine | stevia, | stevia, steviol | tomatine | asparagine, |
| | | erythritol, | glycoside | | tomatine |
| | | tomatine | | | |
| Proof | 16.5 | 16.5 | 16.5 | 16.9 | 16.9 |
| pH | 8.55 | 8.21 | 7.77 | 8.50 | 7.55 |
| Brix(%) | 0.13 | 0.15 | 0.12 | 0.02 | 0.11 |

TABLE 9

| | Comparison | Comparison | Comparison | Comparison | Comparison | Sample |
|---|---|---|---|---|---|---|
| Classification | A | B | C | D | E | 6 |
| Sensory | 4.3 | 3.8 | 4.1 | 3.7 | 3.8 | 4.8 |
| inspector 1 | | | | | | |
| Sensory | 4.5 | 3.7 | 4.1 | 3.7 | 3.7 | 4.9 |
| inspector 2 | | | | | | |
| Sensory | 4.2 | 4.2 | 4 | 3.8 | 4.1 | 4.9 |
| inspector 3 | | | | | | |
| Sensory | 4.1 | 3.7 | 3.5 | 3.5 | 3.7 | 5 |
| inspector 4 | | | | | | |
| Sensory | 4.5 | 3.5 | 3.7 | 3.5 | 3.9 | 4.9 |
| inspector 5 | | | | | | |
| Sensory | 4.4 | 4.1 | 3.5 | 3.8 | 3.8 | 4.9 |
| inspector 6 | | | | | | |
| Sensory | 4.3 | 3.7 | 3.8 | 3.8 | 4 | 4.8 |
| inspector 7 | | | | | | |
| Sensory | 4.3 | 3.8 | 3.7 | 3.5 | 4 | 5 |
| inspector 8 | | | | | | |
| Sensory | 4.2 | 3.9 | 3.6 | 3.7 | 4.2 | 5 |
| inspector 9 | | | | | | |
| Sensory | 4.1 | 4.1 | 3.8 | 3.7 | 3.9 | 4.9 |
| inspector 10 | | | | | | |
| Average | 4.29 | 3.85 | 3.78 | 3.67 | 3.91 | 4.95 |

(In Table 9 above, the higher the score is (the closer to 5 points), it means that the bitterness is less)

As a result, it was confirmed that Soju of Sample 6 comprising salt had a higher score, compared to other Soju comprising sugar instead of salt, and therefore, the bitterness was reduced relatively more.

### Example 3. Sensory Test According to Soju Preparation Condition

### Example 3-1. Sensory Test According to Soju Preparation Condition by Salt Type

For the Soju prepared in Example 1-1 above, a sensory test according to a Soju preparation condition was conducted by the type of salt comprised in Soju.

Specifically, the Andes lake salt, Himalaya pink salt or Sinan gray salt of Example 1-2 above was added as table salt, respectively, and in the preparation method of Example 1-1 above, using ethanol at a concentration of 38% (v/v), 30% (v/v), 25% (v/v), or 20% (v/v), respectively, by three methods of a method for preparation by the substantially same method as Example 1-1 above (Table 10), a method for preparation by setting a stirring temperature to 25° C., 20° C., 15° C., or 10° C. (Table 11), and a method for preparation by ultrasonication under a common sonication, heating in boiling water at 40 to 50° C., or aeration for 2 minutes and 30 seconds while stirring (Table 12), and the sensory test prepared by each of the three methods was conducted by the substantially same method as Example 2-1 above, and the result was shown in Tables 10 to 12 below, respectively. The result values of Tables 10 to 12 below are described as average values of Example 2-1 above and the scores of the sensory inspectors 1 to 10 after the substantial sensory test.

TABLE 10

| Classification | Ethanol 38% | Ethanol 30% | Ethanol 25% | Ethanol 20% |
|---|---|---|---|---|
| Andes salt | 4.8 | 4.2 | 4.1 | 3.9 |
| Himalaya pink | 4.7 | 4.5 | 4.1 | 3.8 |
| salt | | | | |
| Gray salt | 4.8 | 4.4 | 3.8 | 3.8 |
| Average | 4.76 | 4.37 | 4 | 3.83 |

TABLE 11

| Classification | 25° C. | 20° C. | 15° C. | 10° C. |
|---|---|---|---|---|
| Andes salt | 3.2 | 3.9 | 4.9 | 4.3 |
| Himalaya pink salt | 3.4 | 3.8 | 4.8 | 4.5 |
| Gray salt | 3.7 | 3.8 | 4.9 | 4.5 |
| Average | 3.43 | 3.83 | 4.87 | 4.43 |

TABLE 12

| | | Heating in | |
|---|---|---|---|
| Classification | Ultrasonication | boiling water | aeration |
| Andes lake salt | 3.2 | 3.9 | 4.9 |
| Himalaya pink salt | 3.4 | 3.8 | 4.8 |
| Gray salt | 3.7 | 3.8 | 4.9 |
| Average | 3.43 | 3.83 | 4.87 |

(In Tables 10 to 12 above, the higher the score is (the closer to 5 points), it means that the bitterness is less)

As a result, it was confirmed that the bitterness was reduced the most, when aeration treatment was performed with an ethanol concentration of 38% (v/v) at a temperature of 15° C. during preparation of the Soju comprising salt.

### Example 3-2. Sensory Test According to Various Soju Preparation Conditions

For the Soju prepared in Example 1-1 above, a sensory test was performed according to Soju preparation conditions.

Specifically, in the method for preparation by the substantially same method as the preparation method of Example 1-1 above by adding salt 6 of Example 1-2 above as table salt and setting the stirring temperature to 15° C. and the ethanol concentration of 38% (v/v), 30% (v/v), 25% (v/v), or 20% (v/v), Soju was prepared by each method by dividing into methods for performing aeration for 2 minutes and 30 seconds, ultrasonication under a general sonication condition and heating in boiling water at 40 to 50° C., and the sensory test was conducted with Soju prepared as such by the substantially same method as Example 2-1 above, and the result was shown in Tables 13 to 15 below.

TABLE 13

| | Temperature: 15° C. | Temperature: 15° C. | Temperature: 15° C. | Temperature: 15° C. |
|---|---|---|---|---|
| | Ethanol | Ethanol | Ethanol | Ethanol |
| | concentration: 38% | concentration: 30% | concentration: 25% | concentration: 20% |
| Classification | Aeration | Aeration | Aeration | Aeration |
| Sensory | 4.9 | 4.3 | 3.8 | 3.9 |
| inspector 1 | | | | |
| Sensory | 4.9 | 4.4 | 3.9 | 3.8 |
| inspector 2 | | | | |
| Sensory | 4.8 | 4.5 | 3.8 | 3.9 |
| inspector 3 | | | | |
| Sensory | 5 | 4.3 | 3.7 | 3.7 |
| inspector 4 | | | | |
| Sensory | 5 | 4.5 | 3.9 | 3.7 |
| inspector 5 | | | | |
| Sensory | 4.9 | 4.5 | 3.8 | 3.5 |
| inspector 6 | | | | |
| Sensory | 4.8 | 4.5 | 3.8 | 3.6 |
| inspector 7 | | | | |
| Sensory | 4.8 | 4.6 | 3.9 | 3.8 |
| inspector 8 | | | | |
| Sensory | 4.9 | 4.5 | 3.9 | 3.9 |
| inspector 9 | | | | |
| Sensory | 5 | 4.3 | 3.7 | 3.8 |
| inspector 10 | | | | |
| Average | 4.9 | 4.44 | 3.82 | 3.76 |

TABLE 14

| | Temperature: 15° C. | Temperature: 15° C. | Temperature: 15° C. | Temperature: 15° C. |
|---|---|---|---|---|
| | Ethanol | Ethanol | Ethanol | Ethanol |
| | concentration: 38% | concentration: 30% | concentration: 25% | concentration: 20% |
| Classification | Ultrasonication | Ultrasonication | Ultrasonication | Ultrasonication |
| Sensory | 3.5 | 3.4 | 3.2 | 3.7 |
| inspector 1 | | | | |
| Sensory | 3.6 | 3.3 | 3.3 | 3.7 |
| inspector 2 | | | | |
| Sensory | 3.6 | 3.5 | 3.4 | 3.4 |
| inspector 3 | | | | |
| Sensory | 3.6 | 3.6 | 3.2 | 3.5 |
| inspector 4 | | | | |
| Sensory | 3.7 | 3.3 | 3.3 | 3.6 |
| inspector 5 | | | | |
| Sensory | 3.8 | 3.4 | 3.5 | 3.4 |
| inspector 6 | | | | |
| Sensory | 3.6 | 3.6 | 3.4 | 3.5 |
| inspector 7 | | | | |
| Sensory | 3.6 | 3.9 | 3.3 | 3.6 |
| inspector 8 | | | | |
| Sensory | 3.5 | 3.5 | 3.4 | 3.4 |
| inspector 9 | | | | |
| Sensory | 3.7 | 3.6 | 3.3 | 3.5 |
| inspector 10 | | | | |
| Average | 3.62 | 3.51 | 3.33 | 3.53 |

TABLE 15

| | Temperature: 15° C. | Temperature: 15° C. | Temperature: 15° C. | Temperature: 15° C. |
|---|---|---|---|---|
| | Ethanol | Ethanol | Ethanol | Ethanol |
| | concentration: 38% | concentration: 30% | concentration: 25% | concentration: 20% |
| | Heating in boiling | Heating in boiling | Heating in boiling | Heating in boiling |
| Classification | water | water | water | water |
| Sensory | 3.9 | 3.8 | 3.8 | 3.7 |
| inspector 1 | | | | |
| Sensory | 3.8 | 3.6 | 3.6 | 3.5 |
| inspector 2 | | | | |
| Sensory | 3.8 | 3.6 | 3.5 | 3.5 |
| inspector 3 | | | | |
| Sensory | 3.9 | 3.7 | 3.5 | 3.4 |
| inspector 4 | | | | |
| Sensory | 4.1 | 3.7 | 3.7 | 3.6 |
| inspector 5 | | | | |
| Sensory | 3.9 | 3.8 | 3.7 | 3.6 |
| inspector 6 | | | | |
| Sensory | 3.9 | 3.8 | 3.6 | 3.5 |
| inspector 7 | | | | |
| Sensory | 4.1 | 3.9 | 3.5 | 3.5 |
| inspector 8 | | | | |
| Sensory | 4.1 | 3.6 | 3.5 | 3.4 |
| inspector 9 | | | | |
| Sensory | 3.8 | 3.7 | 3.4 | 3.4 |
| inspector 10 | | | | |
| Average | 3.93 | 3.72 | 3.58 | 3.51 |

(In Tables 13 to 15 above, the higher the score is (the closer to 5 points), it means that the bitterness is less)

As a result, as the sensory test score was high in all the cases in that aeration was treated at 15° C., and ultrasonication was treated, and heating in boiling water was conducted, and therefore, it was confirmed that the bitterness was reduced the most at an ethanol concentration of 38% (v/v).

1. An alcoholic beverage, comprising at least one salt selected from the group consisting of lake salt, rock salt and solar salt, and ethanol.

2. The alcoholic beverage according to claim 1, wherein the salt is comprised in an amount of 0.00001 to 0.01% (w/v) in the alcoholic beverage.

3. The alcoholic beverage according to claim 2, wherein the salt comprises lake salt, rock salt and solar salt at a weight ratio of 6:3:1 to 8:1:1 (lake salt:rock salt:solar salt), respectively.

4. The alcoholic beverage according to claim 1, comprising ethanol at a concentration of 5 to 30% (v/v) based on 100% of the alcoholic beverage volume.

5. The alcoholic beverage according to claim 1, wherein the alcoholic beverage is diluted or distilled Soju.

6. The alcoholic beverage according to claim 1, wherein the ethanol is provided as fermented spirit, deodorized spirit, or distilled Soju crude solution.

7. The alcoholic beverage according to claim 1, having a characteristic of reduced bitterness compared to alcoholic beverages not comprising at least one salt selected from the group consisting of lake salt, rock salt and solar salt.

8. The alcoholic beverage according to claim 1, wherein the lake salt is Andes lake salt;
the rock salt is Himalaya pink salt; or
the solar salt is gray salt.

9. The alcoholic beverage according to claim 1, wherein the alcoholic beverage is Soju.

10. A preparation method of an alcoholic beverage, comprising adding at least one salt selected from the group consisting of lake salt, rock salt and solar salt to ethanol; and
stirring ethanol to which the salt is added.

11. The preparation method of an alcoholic beverage according to claim 10, wherein the salt is added to be 0.00001 to 0.01% (w/v) in the alcoholic beverage.

12. The preparation method of an alcoholic beverage according to claim 11, wherein the salt comprises lake salt, rock salt and solar salt at a weight ratio of 6:3:1 to 8:1:1 (lake salt:rock salt solar salt), respectively.

13. The preparation method of an alcoholic beverage according to claim 10, wherein the concentration of ethanol in the adding salt is 10 to 50% (v/v).

14. The preparation method of an alcoholic beverage according to claim 10, wherein the stirring is performed by aeration, ultrasonication or hot water treatment.

15. The preparation method of an alcoholic beverage according to claim 14, wherein the aeration is performed for 1 minute to 5 minutes.

16. The preparation method of an alcoholic beverage according to claim 10, further comprising standing the stirred ethanol; and
filtering the stood ethanol.

17. The preparation method of an alcoholic beverage according to claim 10, wherein the lake salt is Andes lake salt;
the rock salt is Himalaya pink salt; or
the solar salt is gray salt.

18. The preparation method of an alcoholic beverage according to claim 10, wherein the alcoholic beverage prepared by the preparation method has a characteristic of shielding bitterness compared to alcoholic beverages not comprising at least one salt selected from the group consisting of lake salt, rock salt and solar salt.

19. The preparation method of an alcoholic beverage according to claim 18, wherein the alcoholic beverage comprises ethanol at a concentration of 5 to 30% (v/v) based on 100% of the alcoholic beverage volume.

20. A method of shielding bitterness of an alcoholic beverage, comprising adding at least one salt selected from the group consisting of lake salt, rock salt and solar salt to ethanol; and
stirring ethanol to which the salt is added.
